(19) United States
(12) Patent Application Publication
(10) Pub. No.: US 2017/0127098 A1
(43) Pub. Date: May 4, 2017

(54) MODULAR MEDIA CONTENT PLACEMENT IN DIGITAL MEDIA

(71) Applicant: International Business Machines Corporation, Armonk, NY (US)

(72) Inventors: Fernando Barsoba, Morrisville, NC (US); David T. Britt, Greensboro, NC (US)

(21) Appl. No.: 14/927,976

(22) Filed: Oct. 30, 2015

(51) Int. Cl. H04N 21/234; H04N 21/258; H04N 21/858; H04N 21/81

(52) U.S. Cl. CPC H04N 21/23424; H04N 21/812; H04N 21/25891; H04N 21/8586

(57) ABSTRACT

Aspects relate to methods, systems, and processes related to dynamically integrating media content into digital media including, receiving a request to play a digital media having modular media content, determining a content provider content package to be integrated into the digital media, receiving the content provider content package, and integrating the content provider content package into the digital media.

### BACKGROUND

The present disclosure relates generally to media content in digital media and, more specifically, to modular placement of media content in digital media.

With the ongoing shift to digital media for entertainment, traditional methods of advertising have become increasingly ineffective, forcing advertisers to adapt their methods and adopt new technologies. For example, certain devices or products enable users to skip commercial breaks, rendering television commercials ineffective. Likewise, newly available streaming media may offer no commercials. The continuing development of anti-advertisement software (e.g., ad blockers) has limited the reach of advertisements embedded within websites. The resulting adaptations by advertisers have helped to keep advertising relevant, and may incorporate elements (such as the use of browser history and cookie tracking) to place advertisements relevant to a user's interests. These include approaches such as requiring viewers/users to watch an advertisement prior to the start of the digital media or overlaying advertisements on top of the digital media itself.

Product placement within the content of the digital media, e.g., products shown on the screen of a movie and as part of the content, is another example of advertising that may be effective in the digital media transition. Product placement is integrated into the entertainment's narrative and the type of the media in which the content is presented is irrelevant. As an added bonus, integration of the product into the narrative encourages consumers to place attention on the product, and, as the product becomes associated with the narrative itself, can potentially endear the consumers to the product.

### SUMMARY

According to embodiments, a method, system, and computer program product are provided for dynamically integrating media content into digital media including, receiving a request to play a digital media having modular media content, determining a content provider content package to be integrated into the digital media, receiving the content provider content package, and integrating the content provider content package into the digital media.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a flow process of integrating media content into digital media using modular media content in accordance with a non-limiting embodiment of the present disclosure;

FIG. 2 depicts a schematic illustration of viewers viewing digital media incorporating modular media content in accordance with a non-limiting embodiment of the present disclosure; and

FIG. 3 depicts a flow process playing digital content that incorporates modular media content in accordance with a non-limiting embodiment of the present disclosure.

### DETAILED DESCRIPTION

Embodiments described herein are directed to methods and systems of providing customizable and/or changeable media content that is embedded within digital media that is configured to be adapted or modified as the media is presented to a user. For example, embodiments described herein may enable the ability to use a set of variables, e.g., user-specified options, variables learned from the monitoring of user behavior, variables based on a subset of a user's geography, and/or any other set of attributes that may define a user's interests, etc., in order to dynamically select media content, such as advertisements, more likely to be relevant to a user's interests. Further, embodiments described herein may enable the ability to integrate media content and/or an advertisement seamlessly into a narrative of digital media entertainment that is viewed by a user.

In accordance with various embodiments disclosed herein, a framework is provided that allows media, e.g., entertainment, movies, televisions shows, videos, etc., to be produced with a series of media content place-holder elements, hereinafter “modular media content,” throughout the narrative. As the digital media is delivered to a viewer/user, products of interest can be dynamically determined and displayed based on a predetermined value, e.g., by any set of user-based attributes, content provider preferences, and/or media provider preferences. Products that match the modular media content can then be integrated into the digital media as the media is consumed by the viewer/user. The result is that a product may be displayed and/or advertised and may be more likely to be relevant to the user's interests, and, because the product is an integrated part of the narrative, it may be less avoidable and may attract more attention from a viewer/user/consumer. Thus, as described herein, embodiments provide a modular media content delivery technique based on video impainting to ingrate media content, such as advertisements, seamlessly into the narrative of media content.

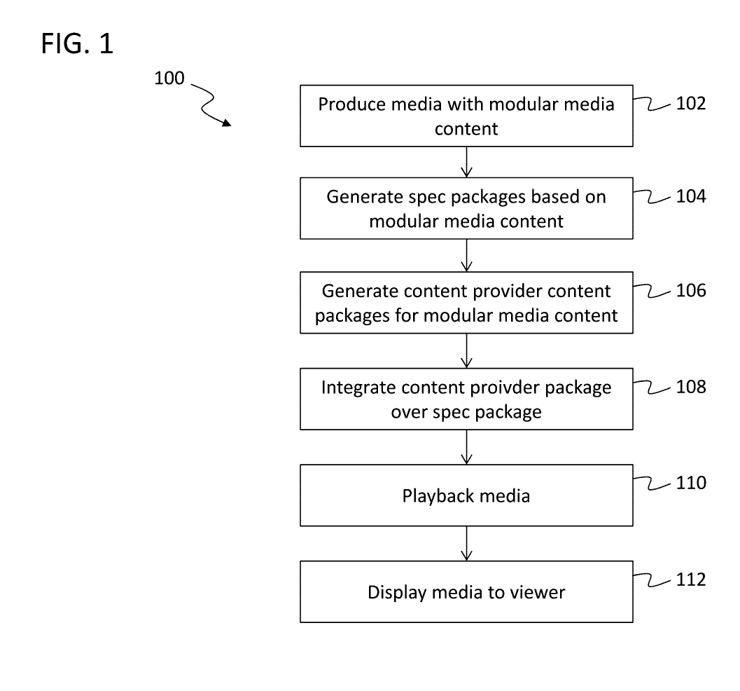

Turning to FIG. 1, a flow process 100 in accordance with a non-limiting embodiment of the present disclosure is shown. Flow process 100 provides a process of generating and displaying media content or advertising content to a user in a narrative of digital media. As discussed herein, digital media may be any type of video or image that may incorporate product placement. In some embodiments, the digital media may be a movie, a television show, a video clip, a slide show, a still image that is displayed on a screen, or any other type of digital media that may include product placement. Modular media content is an item or other feature within the narrative of the digital media that includes product placement, and as described herein, the modular media content may be overlaid or integrated with specific content provider content during reproduction to a user/viewer/consumer, thus enabling dynamic product placement within a narrative of digital media.

As shown, at block 102, digital media is generated containing modular media content. The modular media content may be place-holder elements that are used during the production of the digital media. That is, generic products or images may be used that can later be overlaid with a content provider or advertiser's product image. As such, as used herein, modular media content may be one or more place-holder or generic elements (e.g., products, items, images, etc.) that are used within the content of the production of the media content, i.e., used within the narrative of the digital media.

For example, while shooting a scene for a movie (the narrative of digital media), an actor may wear a modular media content clothing (e.g., shirt, hat, shoes, etc.), the actor may drink from a modular media content bottle, a modular media content television show/commercial may be played in the background of a scene, the actor may drive a modular media content vehicle, the actor may pass in front of store fronts that may be modular media content, etc. Each of these modular media content items/images may be a generic, e.g., fictional, version of the item when the scene is recorded. As such, when viewing the originally filmed scene, the modular media content does not appear out of place to a viewer. The digital media now contains certain aspects that are embedded and part of the narrative of the media content (e.g., place-holder product placement elements) that may be used for dynamic and/or selective delivery of media content.

Based on modular media content in the digital media, one or more specification packages may be generated, as shown at block 104. A specification package may include one or more digital templates that are based on and represent the modular media content in the digital media and can be provided to a content provider, such as an advertiser. The digital templates of the specification packages may include pixel sizes, shading, rotational angles, etc. related to the modular media content as it appears in the narrative of the digital media.

For example, in the case of a bottle that is picked up, held, and consumed by an actor in the narrative of the digital media, a beverage specification package may include information for each situation in that the bottle appears within the narrative including viewing angles, amount of the item visible (e.g., actor's hand covers a portion of the bottle), etc. for the bottle. This may enable digital media content, such as an advertisement, to be generated that may be integrated into the narrative of the digital media for display to a user. For example, a content provider's bottle information and image formed in a content provider content package (based on the specification package) may be overlaid on the modular media content item and to a viewer it will appear that the actor is interacting with and drinking the content provider's product rather than the generic item that was filmed in the production of the digital media.

Various specification packages may be made and distributed to multiple content providers. For example, a drink specification package may be a package that includes all modular media content that is related to drinks, e.g., all bottles, glasses, drink containers, drink advertisements (e.g., billboards, TV commercials, etc.), etc. that are within the narrative of the digital media. Other specification packages may be generated for clothing, vehicles, electronics, or any other content that may be produced as having modular media content. That is, specification packages may be generated for all possible product-placement items within a narrative of a digital media.

Based on the specification packages generated at block 104, one or more content providers may generate content provider content packages, as shown at block 106. The content provider content packages may be digital files or other digital content that represents a content provider's product that may be integrated into the narrative of the digital media and overlaid the modular media content. That is, the content provider content package includes digital information that may match the specification package and thus take the place of the modular media content in the narrative of the digital media.

For example, the content provider content package may be images and data that correlate to the specification packages such that during play-back of the digital media, instead of a viewer seeing the generic version of the modular media content, the view sees the content provider's product. For the integration of the content provider content package into the narrative of the digital media, the content provider content packages may also include a universal resource indicator (“URI”) which enables the content provider content package to be accessed during playback of the media.

For example, the URI may enable access over an internet connection during a streaming of the digital media. In some embodiments, depending on the type of digital media, the content provider content packages may be integrated into the digital media directly or permanently, e.g., in the case of a DVD or other physical media. Further, in some embodiments, a combination of physical media and internet connection may enable a viewer viewing a DVD to have a playback device retrieve a content provider content package over the internet using a provided URI that is stored in the physical media.

One or more content provider content packages may be integrated into the media, as shown at block 108. The content provider content packages may be embedded into the digital media in the form of the URI and a tag associating the URI with particular modular media content within the narrative of the digital media. Thus, when a user selects the digital media for playback, the content provider content package may be retrieved and integrated into the narrative of the digital media by replacing or overlaying the specification package (representative of the modular media content) with the content provider content package.

The media may then be played back, as shown at block 110. The playback may be a running of the integrated narrative of the digital media with the content provider content package. That is, the playback of the digital media is the process of providing an integrated digital media product. In some embodiments, the playback may be streaming from a digital streaming service, playing the digital media at a movie theater, downloading a copy of the digital content, playing on a physical content media player (e.g., DVD player), etc.

The digital content, i.e., the narrative of the digital media plus the integrated content provider content package may be displayed to a viewer, as shown at block 112. That is, as the media is displayed, the content provider's product content in the content provider content package may be overlaid the modular media content, based on the specification package, to generate a single digital content package that includes the narrative with the overlaid product placements. As a result, a viewer may view the digital media with a content provider's product embedded and integrated into the media such that product placement may be provided.

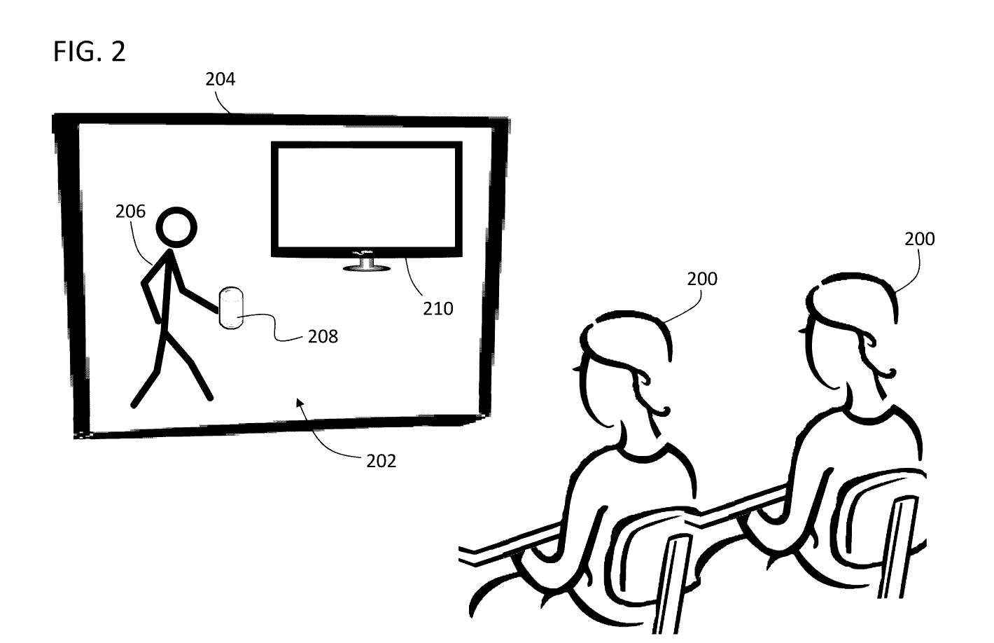

Turning to FIG. 2, an example of viewers observing digital media content with integrated content provider content packages in accordance with a non-limiting embodiment of the present disclosure is shown. FIG. 2 depicts an example of viewers 200 viewing a narrative of digital media 202 displayed on a screen 204. In the scene depicted on the screen 204, an actor or character 206 is shown holding a container 208 (e.g., a beverage) and a television 210 is in the background in the scene of the digital media 202.

During making and production of the digital media 202, the actor/character 206 may wear clothing that is modular media content. For example, the actor/character 206 may wear clothing that is generic or contains fictional information, e.g., fictional product names. Further, the character 206 may hold a modular media content container 208 that is labeled as a generic or fictional beverage. Finally, in this example, the television 210 in the background of the scene of the digital media 202 may be modular media content, e.g., a generic or fictional television brand, and further may display modular media content, e.g., a generic or fictional scene, thereon, such as a commercial or show.

During post-production of the digital media, each of the modular media content elements (e.g., clothing on the character 206, container 208, and television 210 (brand and images thereon) may be digitally formed as part of a specification package. That is, the pixel sizes, shading, rotational angles, duration of content on the screen, etc. may be saved into a specification package that is provided to one or more content providers. The content providers may then generate content provider content packages that fill in the information of the modular media content items within the specification packages. That is, the content provider may generate a package of information and digital data that enables display of the content provider content/products in the media 202 as the media 202 is played to viewers 200.

It will be appreciated by those of skill in the art that if the viewers 200 viewed the digital media 202 without a content provider content package integrated into the narrative, the viewing would not be impacted. For example, the generic versions of the modular media content will be viewed and not appear out of place or improper. However, when the content provider content packages are integrated into the narrative, product placement is provided and the viewers 200 will observe the content provider's products embedded into the narrative.

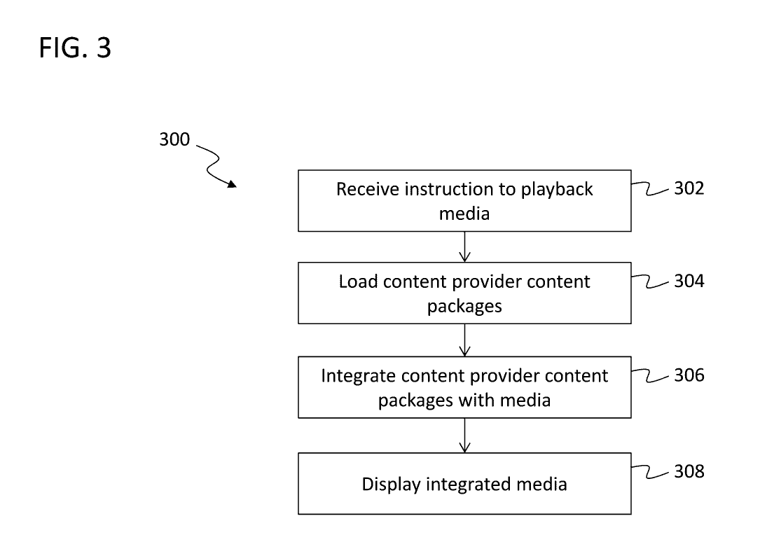

Turning now to FIG. 3, a flow process for selecting and displaying content provider content packages in a narrative of digital media is shown. Flow process 300 may be employed during playback of digital media that contains modular media content in the narrative thereof.

A device, such as a computer, a television, or other user device with playback capabilities, may receive instructions to playback a particular media, e.g., a movie, a television show, a video clip, a slide show, etc., at block 302. The digital media may be played through a website, through a streaming service, may be played from physical media, or may be played from any other media or means without departing from the scope of the present disclosure.

When the digital media is instructed to be played at block 302, the device may obtain and load content provider content packages that are embedded with the media, as shown at block 304. That is, when the digital media is prepared or loaded for playback, the content provider packages may also be obtained and loaded. The content provider package may be selected based on user preferences, playback location, time of day, content provider preferences, based on other criteria, or combinations thereof.

The content provider content package may be obtained based on a URI or other digital content indicator that is embedded in the digital media content of the media to be played. For example, various URI's and other content may be embedded into the information that is used for media playback. Based on the URI, the device may contact a storage device over the internet to load appropriate content provider content packages. For example, a content provider content package may be stored on a server or other device that is managed and operated by the content provider. The URI within the digital media may instruct the device playing the digital media to contact the server of the content provider to obtain specific content provider content packages stored on the servers.

The selection of the content provider content package may be based on a selection process that incorporates user preferences, content provider preferences, and/or other criteria. For example, in some embodiments, a user may generate a user profile with content provider preferences when they sign up for a streaming service. The user preferences may include preferences of the user for specific products or types of products in addition to information related to age, gender, location, etc. When the content provider content packages are to be loaded, the user preferences may be used to select one content provider over another content provider of the same type of product. For example, a user preference may enable one beverage producer's products to be displayed instead of another beverage producer.

In another embodiment, the content provider content package may be based on location of the viewer such that local or regional products are integrated into the narrative of the digital media. In other embodiments, the content provider contact package selection may be based on a contract with the digital media content producer (e.g., movie studio, television network, etc.) and/or with the digital media provider (e.g., digital media streaming service, movie theater, etc.). Further, other criteria may be used to determine and/or select specific content provider content packages. For example, the selection may be based on the time of day that the digital media is shown. Further, the selection may be based on the user profile such that age appropriate content provider content packages may be integrated into the narrative of the digital media.

With the content provider content packages selected and loaded, the information/data may be integrated into the playback of the media, as shown at block 306. Finally, the integrated and combined media may be displayed to a viewer, as shown at block 308, e.g., shown on a screen.

In one non-limiting example, a device may perform flow process 300. The user device may be a computer, a smartphone, a DVD player, a home theater device, a multi-media device, a movie theater projecting device, etc. For example, the device may receive a request to stream a movie over the internet. The device may include or receive user data when the request is made. For example, when a user selects a movie to be played from a streaming service, the request to play the movie may include user data related to products the user has purchased, data related to websites the user has visited, location data based on where the request is made from, time of day, data input directly by the user (e.g., user preferences) and/or other information and/or criteria. In some embodiments, the user data may be similar to cookies used in web browsing, as known in the art. In some embodiments, the user data may be input directly by the user in a user account or other user profile. For example, when the user signs up to use the streaming service, they may create a user profile with media content or advertising preferences.

Based on the user data information, the device may select particular content providers to obtain content provider content packages from to generate an integrated media that has the original content with the content provider content package information overlaid the modular media content within the narrative of the digital media. That is, based on the user data, specific content provider from a plurality of content providers that have content provider content packages for the specific digital media may be selected.

Once the content providers are selected, based on the user data and/or other criteria, the device may obtain the content provider content packages from the appropriate content providers'servers. The device may then deliver a video stream of the media desired by the user. In some embodiments, a buffering delay may be employed by the device such that the content provider content package material may be seamlessly integrated into the scenes that include modular media content.

As will be appreciated by those of skill in the art, the selection and integration of the content provider content packages may be performed at a location other than at the device. For example, in some embodiments, if the digital media is being streamed from a streaming service, the streaming service may perform the above described process. That is, the streaming service may receive a request from a user to play a digital media. When the request is received, the streaming service may also obtain information about the user making the requested. Based on this user information, the streaming service may obtain the appropriate content provider content packages and integrate the content provider content packages into the narrative of the digital media, and thus provide the combined/integrated digital media to the user making the request. In other embodiments, the process may be performed by a movie theater, wherein the digital media may be preloaded with the content provider content packages (and a similar situation may exist for physical media).

As noted above, the selected content provider content packages may be based on user preferences or habits. However, in alternative embodiments, the selected content packages may be based on a host's preferences. As such, if the host is a movie theater, the movie theater may determine the content provider content packages that are selected and displayed in the narrative of the digital media. For example, if the movie theater serves a specific brand of beverage, the theater may wish to have movies played in the theater only have that brand shown on the screens to thus increase consumers purchasing the product at the movie theater. In another embodiment, a content provider may contract with the movie theater such that the content provider's content is preferred and selected to be displayed in movies that are shown at the movie theater.

Further, in some embodiments, the selected content provider content package may be location based. For example, various beverage brands may each have a content provider content package for a specific digital media. When the digital media is selected to be played back, the request for playback may include location or regional information, such that brands that cover certain locations or regions may be selected for display and integration into the narrative of the digital media. Further, as noted, the content provider content package may be selected based on the time of day that the digital media is played back. For example, if a user is viewing a movie in the morning, a bag for a fast-food advertiser may be a breakfast fast-food advertiser, but if the movie is viewed at night, a different fast-food advertiser content package may be used that shows burgers or some other fast-food that may be consumed at dinner time.

In some embodiments, the content provider content packages may be stored and saved by the content provider, rather than stored and saved at a host (e.g., digital media streaming service). In such embodiments, the content provider may be able to update and modify the content provider content packages at any time. For example, a content provider may develop a new product, product configuration, product image, etc., and may wish to have the new product integrated into digital media that displays the content provider's content. The content provider may change or update their specific content provider content package such that a content provider may have a new or updated content provider content package integrated with digital media.

As will be appreciated by those of skill in the art, although beverages are used as a primary example in the above described embodiments, the media content, advertisements, and/or product placements integrated into the digital media are not limited thereto. For example, as mentioned above, content provider content packages may be for beverages, clothing, electronics, vehicles, background items (e.g., televisions, billboards, store fronts, etc.) or any other item that may be in a media production that may be used for product placement. Thus, dynamic product placement is enabled wherein the content provider may have control over what particular product and/or product version may be shown in a narrative of a digital media.

As described herein, the product placement is dynamically provided in near real-time, rather than in post-processing of a production (i.e., permanently part of a narrative). As such, the product placement within the production may not be fixed or permanent, but rather may be changed over time and/or may change what is displayed from one viewing of the digital media to another. For example, if a content provider content package is based on a user profile or other user preference, and the user changes their preferences, the displayed product placement (e.g., the selected and loaded content provider content packages) may change from one viewing of the digital media to the next, if the user preferences change between the two viewings.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A computer implemented method to dynamically integrate media content into digital media, the method comprising:
determining products sold at a host facility;
receiving, by a processor, a request from the host facility to play a digital media having modular media content;
determining a time of day that the digital media is to be displayed;
determining a content provider content package to be integrated into the digital media, the content provider content package based on the determination of products sold at the host facility and the time of day the digital media is to be displayed;
receiving the content provider content package;
integrating the content provider content package with the modular media content of the digital media; and
displaying the digital media containing the content provider content package to a user in the host facility.

2. (canceled)

3. The computer implemented method of claim 1, wherein the integrating and displaying occur substantially simultaneously.

4. The computer implemented method of claim 1, wherein the content provider content package is based on at least one specification package.

5. The computer implemented method of claim 4, wherein the specification package includes at least one of pixel sizes, shading, rotational angles, and duration of content in the digital media, related to an element displayed in the digital media.

6. The computer implemented method of claim 1, wherein the modular media content comprises at least one of a place-holder element or a generic element.

7. (canceled)

8. (canceled)

9. The computer implemented method of claim 1, further comprising inserting a playback buffer such that the content provider content package is seamlessly integrated into the digital media.

10. A system to dynamically integrate media content into digital media, the method comprising:
a memory having computer readable instructions; and
a processor configured to execute the computer readable instructions, the computer readable instructions comprising:
determining products sold at a host facility;
receiving a request from the host facility to play a digital media having modular media content;
determining a time of day that the digital media is to be displayed;
determining a content provider content package to be integrated into the digital media, the content provider package based on the determination of the products sold at the host facility and the time of day the digital media is to be displayed;
receiving the content provider content package;
integrating the content provider content package with the digital media and
displaying the digital media containg the content provider content package to a user in the host facility.

11. (canceled)

12. The system of claim 10, wherein the integrating and displaying occur substantially simultaneously.

13. The system of claim 10, wherein the content provider content package is based on at least one specification package.

14. The system of claim 13, wherein the specification package includes at least one of pixel sizes, shading, rotational angles, duration of content in the digital media, related to an element displayed in the digital media.

15. The system of claim 10, wherein the modular media content comprises at least one of a place-holder element or a generic element.

16. (canceled)

17. (canceled)

18. The system of claim 10, further comprising inserting a playback buffer such that the content provider content package is seamlessly integrated into the digital media.

19. A computer program product to dynamically integrate media content into digital media, the computer program product comprising a non-transitory computer readable storage medium having program instructions embodied therewith, the program instructions executable by a processor to cause the processor to:
determining products sold at a host facility;
receive a request from the host facility to play a digital media having modular media content;
determining a time of day that the digital media is to be displayed;
determine a content provider content package to be integrated into the digital media, the content provider content package being based on the determination of products sold at the host facility and the time of day the digital media is to be displayed;
receive the content provider content package;
integrate the content provider content package with the digital media; and
displaying the digital media content containing the content provider content package to a user in the host facility.

20. The computer program product of claim 19, wherein the specification package includes at least one of pixel sizes, shading, rotational angles, duration of content in the digital media, related to an element displayed in the digital media.
